(19) United States
(12) Patent Application Publication
(10) Pub. No.: US 2025/0245144 A1
(43) Pub. Date: Jul. 31, 2025

(54) NEAR MEMORY PROCESSING DEVICE FOR PROCESSING COEFFICIENT ELEMENTS RESULTING FROM DECOMPOSITION OF POLYNOMIALS

(71) Applicant: INTERNATIONAL BUSINESS MACHINES CORPORATION, ARMONK, NY (US)

(72) Inventors: Yongmo Park, Ann Arbor, MI (US); Subhankar Pal, White Plains, NY (US); Aporva Amarnath, White Plains, NY (US); Alper Buyuktosunoglu, White Plains, NY (US); Pradip Bose, Yorktown Heights, NY (US)

(21) Appl. No.: 18/424,145

(22) Filed: Jan. 26, 2024

(51) Int. Cl. G06F 12/02; G06F 17/11

(52) U.S. Cl. CPC G06F 12/0238; G06F 17/11

(57) ABSTRACT

Provided are a near memory device, system, and method for processing coefficient elements resulting from decomposition of polynomials. The near memory device includes a plurality of enclaves and a plurality of interconnected tiles on each enclave. A tile includes a memory and a processing element to perform operations on decomposed coefficients stored in the memory of the tile. An enclave controller in an enclave of the enclaves receives an operation for coefficients of a polynomial. Each of the coefficients are decomposed into a number of levels of coefficient elements. The enclave controller distributes the coefficient elements to the tiles in the enclave to have processing elements of the tiles load and process the coefficient elements and store the processed results.

### BACKGROUND OF THE INVENTION

### 1. Field of the Invention

The present invention relates to a near memory device, system, and method for processing coefficient elements resulting from decomposition of polynomials.

### 2. Description of the Related Art

Fully homomorphic encryption (FHE) is an encryption technique that enables computations on encrypted data, or ciphertext, without decrypting the data to maintain the data protected at all times. Processing homomorphic operations on the encrypted data is orders of magnitude slower than operations on the unencrypted data. FHE operations are time consuming because they involve processing long and wide polynomials as operands and have low data reusability. Further, conventional hardware, such as central processing units (CPUs) and graphics processing units (GPUs) have difficulty processing polynomials efficiently due to their small on-chip memory. For these reasons, FHE operations require large off-chip data transfer between computing and memory modules.

Prior art approaches for accelerating FHE operations involve use of application specific integrated circuits (ASICs) with large on-chip memory sizes. However, even using large on-chip memory in the ASIC is not sufficient to store all of the required data, in particular, the large keys, for FHE operations, requiring data streaming from off-chip memory.

### SUMMARY

Provided are a near memory device, system, and method for processing coefficient elements resulting from decomposition of polynomials. The near memory device includes a plurality of enclaves and a plurality of interconnected tiles on each enclave. A tile includes a memory and a processing element to perform operations on decomposed coefficients stored in the memory of the tile. An enclave controller in an enclave of the enclaves receives an operation for coefficients of a polynomial. Each of the coefficients are decomposed into a number of levels of coefficient elements. The enclave controller distributes the coefficient elements to the tiles in the enclave to have processing elements of the tiles load and process the coefficient elements and store the processed results.

Provided are a near memory device, system including a near memory device, and method for processing coefficient elements resulting from decomposition of polynomials. The near memory device includes a plurality of enclaves including a plurality of processing tiles. A tile includes an even memory bank and an odd memory bank with row buffers and a processing element coupled to the even memory bank and the odd memory bank. A tile controller receives coefficients of a polynomial decomposed into a number of levels of coefficient elements and stores the coefficient elements in the even memory bank and the odd memory bank. The tile controller directs the processing element in the tile to process the coefficient elements in the row buffers to perform an operation on the coefficient elements and write back the operated on coefficient elements to at least one of the even memory bank and the odd memory bank to return to the enclave.

### BRIEF DESCRIPTION OF THE DRAWINGS

FIG. 1 illustrates an embodiment of a system for processing decomposed polynomials.

FIG. 2 illustrates an embodiment of a near memory processing device substrate.

FIG. 3 illustrates an embodiment of a hierarchical command list for processing at a near memory processing device.

FIG. 4 illustrates an example of a hierarchical command list.

FIG. 5 illustrates an example of a Residue Number System (RNS) decomposed polynomial a(X).

FIG. 6 illustrates an example of operations on the decomposed coefficients of two polynomials in a ciphertext.

FIG. 7 illustrates an embodiment of limb-wise operations on coefficient elements of polynomials.

FIG. 8 illustrates an embodiment of coefficient-wise operations on coefficient elements of polynomials.

FIG. 9 illustrates an embodiment of element-wise operations on coefficient elements of polynomials.

FIG. 10 illustrates an embodiment of ciphertext-wise operations on coefficient elements of polynomials.

FIG. 11 illustrates an example of a dataflow of ciphertext-to-ciphertext multiplication of polynomials.

FIG. 12 illustrates an example of Inverse Number Theoretic Transform (INTT) operations in a near memory processing substrate.

FIG. 13 illustrates an example of a dataflow for a base conversion operation.

FIGS. 14A through 14H illustrate the processing of the decomposed digits of the polynomials in enclaves or a near memory processing substrate as part of the base conversion operation that starts with 4 limbs and creates 4 more limbs.

FIG. 15 illustrates an example of processing of decomposed data for coefficients of polynomials in row buffers of a tile.

FIG. 16 illustrates an example of a timing diagram of the row buffer operations described with respect to FIG. 15.

FIG. 17 illustrates an embodiment of a system to compile fully homomorphic encryption (FHE) operations in an application into directed acyclic graphs (DAGs).

FIG. 18 illustrates an embodiment of component status of a component represented in an NMP device model.

FIG. 19 illustrates an embodiment of directed acyclic graphs produced by the compiler to execute FHE operations in an application.

FIG. 20 illustrates an embodiment of operations to compile an application having FHE operations.

FIG. 21 illustrates a computing environment in which the components of FIGS. 1 and 17 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A near memory device for performing operations on decomposed polynomials, comprising a plurality of enclaves and a plurality of interconnected tiles on each enclave. A tile includes a memory and a processing element to perform operations on decomposed coefficients stored in the memory of the tile. An enclave controller in an enclave of the enclaves is operable to receive an operation for coefficients of a polynomial, wherein each of the coefficients are decomposed into a number of levels of coefficient elements, and distribute the coefficient elements to the tiles in the enclave to have processing elements of the tiles load and process the coefficient elements and store the processed results. Thus, embodiments advantageously provide a memory device having a hierarchy of enclaves and interconnected tiles in each enclave to optimize operations processing decomposed coefficient elements of polynomials by allowing parallel processing of the coefficient elements in tiles within enclaves and across enclaves.

Example 2: The subject matter of Examples 1 and 3-7 can optionally include that each level of coefficient elements comprises a limb and each enclave processes the coefficient elements for one of the limbs. Thus, embodiments advantageously allow parallel processing of limbs of decomposed coefficient elements of a polynomial by having each of the enclaves in parallel process the coefficient elements for the limbs to optimize polynomial limb operations.

Example 3: The subject matter of Examples 1, 2, and 4-7 can optionally include that each of the enclaves includes an interconnection network between the tiles to enable data transfer between the tiles within one enclave. The operations on the coefficient elements in the enclave comprises the tiles communicating to perform the operations on the coefficient elements. Thus, embodiments advantageously allow the tiles within the enclaves to in parallel process coefficient elements by allowing the tiles in an enclave to simultaneously transfer data across tiles within each of the enclaves using interconnection networks between tiles in the enclaves. This allows parallel processing at the tiles in different enclaves communicating with other tiles in the same enclave to optimize operations across the enclaves.

Example 4: The subject matter of Examples 1-3 and 5-7 can optionally include coefficient elements for one limb are processed in the tiles of only one enclave. Thus, embodiments advantageously allow each of the enclaves to in parallel process coefficients for one of the limbs to optimize limb operations across the enclaves.

Example 5: The subject matter of Examples 1-4, 6, and 7 can optionally include that the near memory device further includes a plurality of substrates. Each substrate includes a plurality of the enclaves. Each enclave in the substrate is connected to two or more other enclaves in the substrate. Thus, embodiments advantageously allow further parallelism at a higher substrate level in the near memory device to allow for enclaves across substrates to process the decomposed coefficient elements in parallel.

Example 6: The subject matter of Examples 1-5, and 7 can optionally include that the substrates are implemented in at least one semiconductor device, and wherein the substrates include connections to communicate with other of the substrates. Thus, embodiments advantageously allow for compact implementation of the near memory device on a single semiconductor device having the substrates that allow parallelism of execution across enclaves in different substrates. Implementing the near memory device in single semiconductor device further allows for fast communication between substrates, enclaves and tiles by avoiding to have to communicate of the semiconductor device.

Example 7: The subject matter of Examples 1-6 can optionally include that the enclave controller instructs the processing elements in the tiles to perform operations on coefficient elements in memory buffers of the tiles comprising operations that are a member of a set of operations consisting of modular addition, modular subtraction, modular multiplication, and power-of-2 radix butterfly operations. Thus, embodiments advantageously allow for tiles to simultaneously perform different sets of operations on the decomposed coefficient elements to optimize processing of multiple primitive operations to perform on the coefficient elements of polynomials.

Example 8: A near memory device for processing operations on decomposed polynomials that includes a plurality of enclaves, where a plurality of processing tiles are in the enclaves. A tile includes an even memory bank and an odd memory bank with row buffers and a processing element coupled to the even memory bank and the odd memory bank. A tile controller is operable to receive coefficients of a polynomial decomposed into a number of levels of coefficient elements. The tile controller is further operable to store the coefficient elements in the even memory bank and the odd memory bank. The tile controller is further operable to direct the processing element to in the tile process the coefficient elements in the row buffers to perform an operation on the coefficient elements and write back the operated on coefficient elements to at least one of the even memory bank and the odd memory bank to return to the enclave. Thus, embodiments advantageously allow for parallel processing of decomposed coefficient elements in tiles within one enclave and in tiles across the enclaves to optimize the processing of the coefficient elements. Embodiments further advantageously allow for different primitives to be processed on the coefficient elements in the polynomials in parallel across enclaves.

Example 9: The subject matter of Examples 8, 10-13 can optionally include that memory buffers to which the coefficient elements are written comprises a first row buffer in the even and the odd memory banks of the tile, wherein a second row buffer of the even and the odd memory banks prepares to load the next coefficient elements in response to the processing element performing the operation on the coefficient elements from the first row buffer in the even and the odd memory banks. Thus, embodiments advantageously allow that while processing coefficient elements in the first row buffer, next coefficient elements are loaded into the second row buffer to be immediately ready to be processed by the processing element when completing processing the coefficient elements in the first row buffer to optimize processing.

Example 10: The subject matter of Examples 8, 9, and 11-13 can optionally include that a third row buffer of the even memory bank or odd memory bank stores output of the processing element from first row buffer of the even memory bank and the odd memory bank. A fourth row buffer of the even or odd memory bank stores output of the processing element that is based on processing coefficient elements from the second row buffer of the even memory bank and the odd memory bank. Thus, embodiments advantageously allow for additional row buffers to store the output of the processing of the coefficient elements so that the output can be independently stored to allow further processing and combinations of the output of the processing of the coefficient elements in the first and the second row buffers.

Example 11: The subject matter of Examples 8-10, 12, and 13 can optionally include that one of the even and the odd memory banks of row buffers include source data of the coefficient elements and one of another of the even and the odd memory banks of the row buffers stores a result of a processing operation on the source data after a phase of the operation comprising a butterfly operation, is completed, the source data and destination data are swapped. Thus, embodiments advantageously allow for a butterfly operation on decomposed coefficient elements to be performed in one of the tiles to allow parallel processing of butterfly operations on coefficient elements in multiple tiles to optimize butterfly operation processing.

Example 12: The subject matter of Examples 8-11 and 13 can optionally include that the coefficient elements for one limb from two polynomials are written in first and the second row buffers to be operated on by the processing element. Thus, embodiments advantageously allow for parallel processing of coefficient elements for the limbs of two polynomials in multiple tiles to optimize the processing of the limbs for two polynomials in tiles of one enclave that processes the coefficient elements for one of the limbs.

Example 13: The subject matter of Examples 8-12 can optionally include a plurality of substrates, wherein each substrate includes a plurality of the enclaves, and wherein each enclave in the substrate is connected to two or more other enclaves in the substrate. Thus, embodiments advantageously allows for additional parallelization by parallel processing coefficient elements for polynomials across enclaves in a plurality of substrates. This provides for parallelization of the processing of the coefficient elements across tiles in each of the substrates to allow parallelization of processing across different levels of the hierarchy of hardware components of the near memory device.

Example 14 comprises a system including the near memory device of any of Examples 1-13 to process commands from an application executing in the system.

Example 15 comprises a method using the near memory device of Examples 1-13 to process decomposed coefficient elements of a polynomial.

Current computational cryptographic operations suffer from large data sizes and bandwidth constraints. Described embodiments provide improvements to computer technology for processing cryptographic and FHE operations by providing an implementation of a Near-DRAM processing (NDP) architecture to reduce the data movement between memory and processor by processing data-intensive computations close to the Dynamic Random Access Memory (DRAM), without having to stream data off-chip, leading to better performance and energy efficiency. Near-DRAM processing may utilize DRAM internal high bandwidth and energy-efficient (pJ/bit) memory access, which is far more efficient and faster than accessing DRAM memory from off-chip. The high density of DRAM cells enables up to 100s of GBs memory capacity that can be used directly for computation.

Described embodiments provide a near memory processing (NMP) hierarchical architecture of an NMP device having a plurality of NMP substrates, where each substrate includes a plurality of enclaves. Each enclave, in turn, includes a plurality of tiles. In certain embodiments, each tile includes pairs of DRAM banks with memory buffers, labeled even and odd banks, and one or more processing elements (PEs). Described embodiments apply the NMP hierarchical architecture to perform parallel processing of coefficient elements derived from a decomposition of a polynomial having N coefficients to produce a number of levels of decomposed coefficient elements. Each level of coefficient elements comprises a limb. Described embodiments assign the coefficient elements for one limb to a single enclave to process, so that coefficient elements for different limbs may be processed in parallel in different enclaves of an NMP substrate.

The described NMP architecture embodiments leverage the high capacity of DRAM, to execute end-to-end cryptographic operations without data streaming from off-chip memory, leading to better performance and energy efficiency. Described embodiments provide an NMP architecture with data placement and execution schemes for different data access patterns in FHE and other cryptographic primitives. The described NDP architecture embodiments support different data access patterns in cryptographic computation primitives. Described embodiments provide a data placement and execution scheme enabling parallelism for all different data access patterns in FHE and other cryptographic primitives.

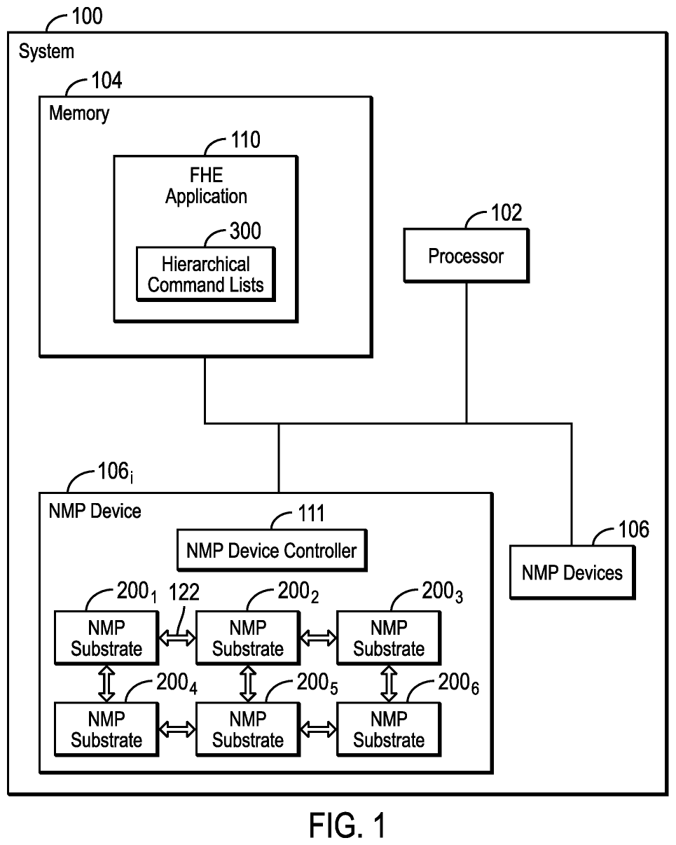

FIG. 1 illustrates a system 100 to perform homomorphic encryption operations, and includes a processor 102, such as one or more processor and cores, a memory 104 and near memory processing (NMP) devices 106 that communicate over a bus 108. A memory 104 contains an FHE application 110 having homomorphic encryption operations on ciphertext polynomials. The application 110 includes hierarchical command lists 300 that map commands to perform operations on decomposed polynomials to a hierarchy of hardware components in the NMP devices 106 to perform operations on coefficient elements comprising decomposed polynomial coefficients in parallel.

An NMP device 106i, comprising one of the NMP devices 106, includes an NMP device controller 111 to distribute commands 118 to a plurality of NMP substrates 200₁, 200₂ . . . 200ₙ, which perform primitive operations on ciphertext polynomials. The NMP devices 106, may comprise a semiconductor device or package, and the NMP substrates 200₁, 200₂ . . . 200ₙ may comprise a substrate or sub-processing units of the NMP device 106ᵢ. The NMP substrates 200₁, 200₂ . . . 200ₙ may comprise chiplets on a semiconductor package. In the embodiment of FIG. 1, each of the NMP substrates 200ᵢ can communicate with neighboring NMP substrates via substrate communication paths, such as communication path 122.

Described embodiments are described with respect to decomposed polynomial operations. The decomposed polynomial operations may be performed for FHE operations and other polynomial operations that are not FHE operations.

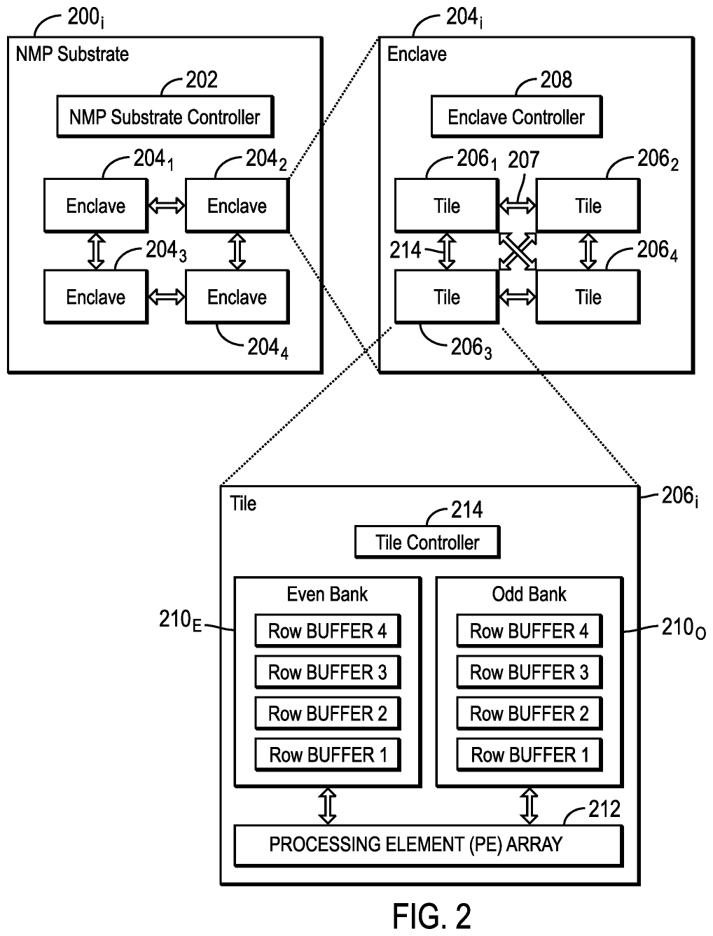

FIG. 2 illustrates an embodiment of the components and sub-components of an NMP substrate 200ᵢ, and includes an NMP substrate controller 202 to distribute commands to a plurality of enclaves 204₁, 204₂, 204₃, 204₄ of the substrate 200ᵢ. Each enclave 204ᵢ on an NMP substrate 200ᵢ includes a plurality of processing tiles 206₁, 206₂, 206₃, 206₄ and an enclave controller 208 to distribute commands to the tiles 206₁, 206₂, 206₃, 206₄. Each of the tiles 206ᵢ includes near memory components, such as an even bank 210_{E} and odd bank 210_{O} with row buffers to store data that may be accessed and processed by a processing element (PE) array 212, which consists of one or more PEs. The even 210_{E} and odd 210_{O} banks with row buffers may be implemented in a memory device such as a DRAM and other suitable high-density memory devices.

FIG. 2 shows a double bank architecture of the memory. Both banks 210_{E} and 210_{O} may have source data, and one of the double banks is for destination of the operations on the source data. Each of the double banks 210_{E}, 210_{O} of the tile 206ᵢ may implement a quadruple-buffer architecture to keep the processing element array 212 active. While the processing element array 212 accesses input data from a row buffer, to keep the processing element array 212 active, a tile controller 214 may ACTIVATE the next row into another row buffer to receive further source data. To avoid overwriting input data in the row buffer with output from the processing element array 212, the processing element array 212 may write into another row buffer for the destination.

The NMP embodiments reduce the data movement between memory and off-chip processor by having the processing element array 212 that processes data intensive computations in nearby DRAM memory elements 210_{E}, 210_{O}. The processing element array 212 utilizes DRAM internal high bandwidth and energy-efficient (small pJ/bit) memory access, compared to accessing DRAM memory from off-chip. All tiles 206₁, 206₂, 206₃, 206₄ may be interconnected, such as with connection 207. In one embodiment, tile-to-tile connections may consist of a network of MUXes. The processing element array 212 may comprise a set of reconfigurable processing elements designed to perform different operations involved in cryptographic arithmetic, such as modular additions, subtractions, multiplications, and modular power-of-2 radix Cooley-Tukey and Gentleman-Sande butterflies.

The memory 104 and 210_{E} and 210_{O} may comprise a suitable volatile or non-volatile memory devices known in the art to store program components for execution, such as DRAM.

The controllers 111, 202, 208, and 214 may comprise a hardware device having programmable code, such as firmware, to perform the operations of the hierarchical components of the NMP device 106ᵢ, including an NMP substrate controller 202, enclave controller 208, and tile controller 214.

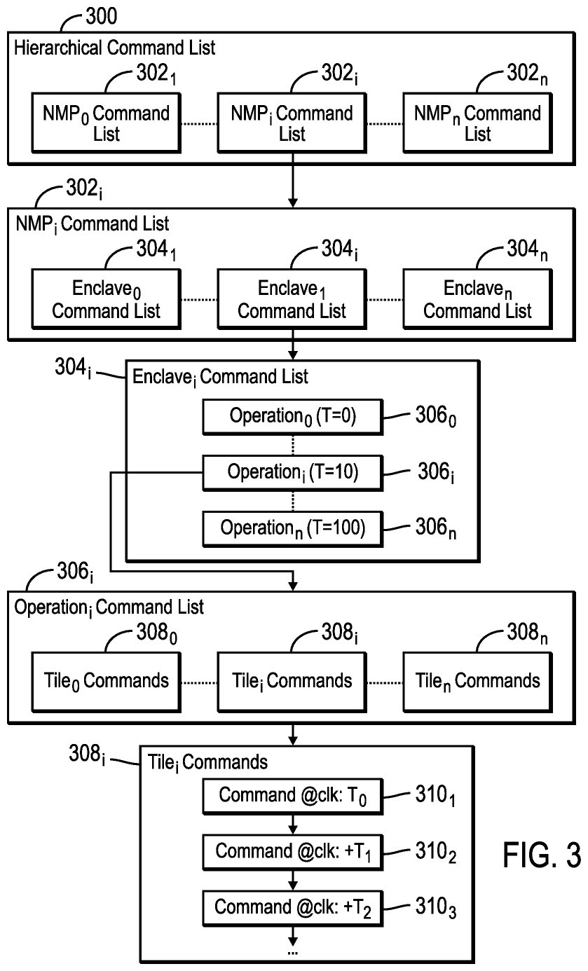

FIG. 3 illustrates an embodiment of a hierarchical command list 300, and its subcomponents, such as the commands that map to NMP substrates 200ᵢ, enclaves 204ᵢ, and tiles 206ᵢ of an NMP device 106ᵢ. The hierarchical command list 300, to be processed by the NMP device controller 111, includes one or more NMP command lists 302₀ . . . 302ᵢ . . . 302ₙ, which are distributed to NMP substrate controllers 202. Each NMPᵢ command list 302ᵢ includes one or more enclave command lists 304₀ . . . 304ᵢ . . . 304ₙ, which the NMP substrate controller 202 transmits to the target enclaves 204ᵢ. Each enclave command list 304ᵢ that includes operation command lists 306₀ . . . 306ᵢ . . . 306ₙ is distributed to the tiles 206ᵢ in the enclave 204ᵢ by the enclave controller 208. The tile 206ᵢ receiving the enclave command list 304ᵢ performs the operations 306ᵢ on the list. Each operation command list 306ᵢ includes tile commands 308₀ . . . 308ᵢ . . . 308ₙ for the processing element array 212 and the memory banks 210_{E} and 210_{O} of the tiles 206₁, 206₂, 206₃, 206₄ to execute, such as commands 310₁, 310₂, 310₃. The timing sequence specified in the commands 310₁, 310₂, 310₃, e.g., @clk:+Tⱼ may be set when generating the issued commands 118, such as a hierarchical command list 300, including specific timing for the processing element array 212 to execute and process coefficient elements and other data stored in the banks 210_{E}, 210_{O}.

The operations 306ᵢ in the enclave command list 304ᵢ and the commands in the tile commands 308ᵢ include clock cycles indicating a timing on which they are executed in their respective enclave 204ᵢ and tile 206ᵢ, respectively. In this way, operations at the enclave level and tile level can be controlled to execute in different enclaves and tiles at the same time to allow for parallelism at different levels of the hierarchy. Thus, when the NMP command list 302i and the enclave command lists 304i are distributed to substrates and then enclaves, the execution of the operations 306i and commands 310; would occur at the same time in the different enclaves 204ᵢ and tiles 206ᵢ to provide for parallelism of the computations on the coefficient elements in the tiles 206ᵢ.

The command list 300 provides a hierarchical mapping of commands to different hierarchical components in the NMP device 106ᵢ. The mapping in the command list 300 may be based on directed acyclic graphs that provide a hierarchy of operations at nodes in the graph corresponding to the hierarchy of components in an NMP device 106ᵢ.

In described embodiments, variables such as i and n may denote different numbers when used in different instances.

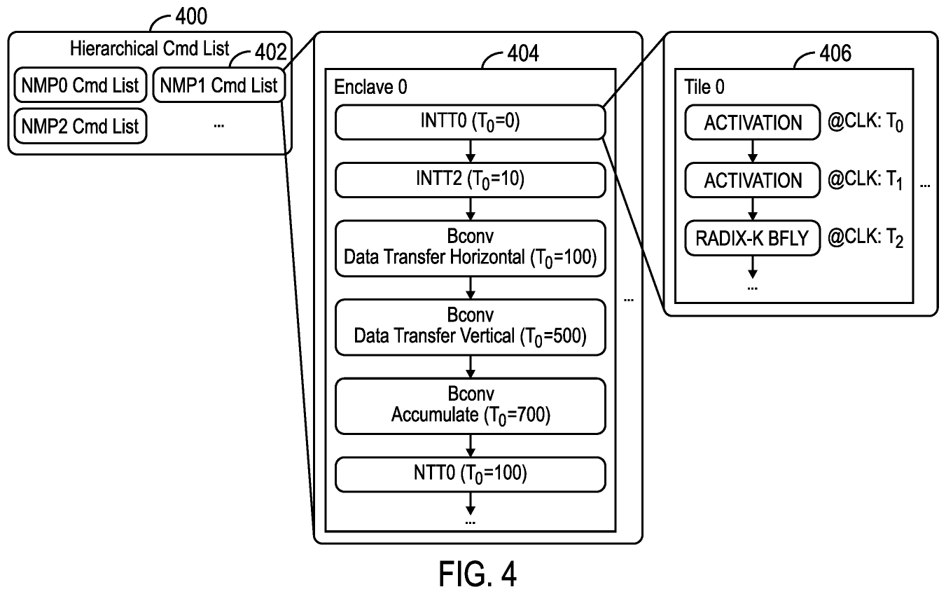

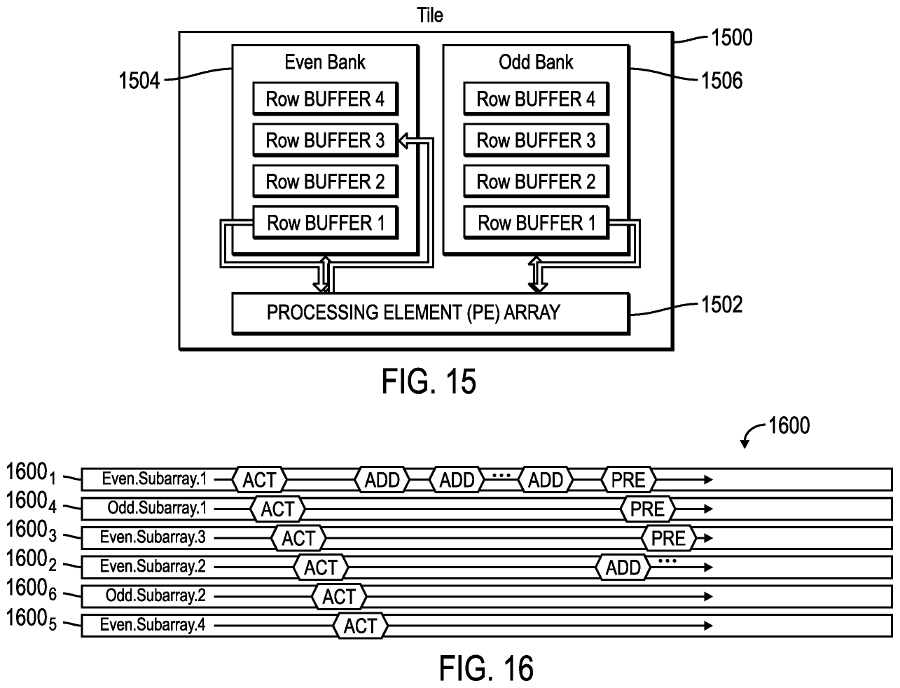

FIG. 4 provides an example of a hierarchical command list 400, or an instance of command list 300, that provides NMP command lists for the NMP substrates 200ᵢ. NMP command list 402 is expanded to show the enclave command list 404 having primitive commands provided for enclave 0, such as an Inverse Number Theoretic Transform (INTT) and base conversion (Bconv) commands, such as Bconv horizontal data transfer, vertical data transfer, and accumulation. The timing for executing the commands in the enclave command list 404 would be added by a compiler as described with respect to FIG. 17 below. Each primitive command in the enclave command list 404 would include tile commands for the tiles in an enclave, such as tile command list 406 for tile 0 in enclave 0, have commands for the tile controller 214 and processing element array 212 to execute at specific clock timing cycles indicated in the hierarchical command list 400.

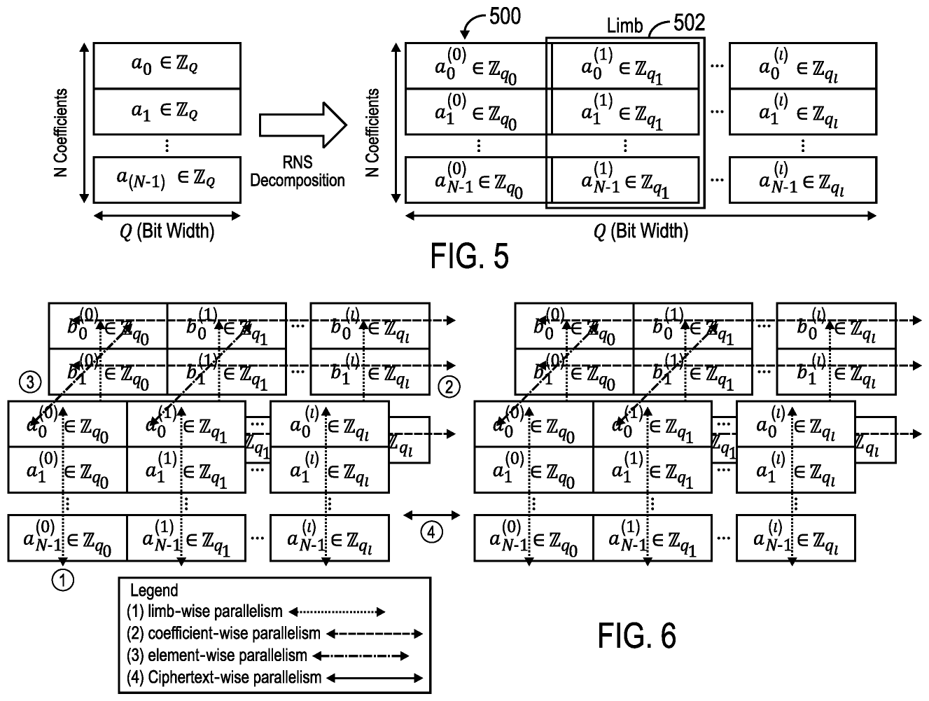

FIG. 5 shows an example of a Residue Number System (RNS) decomposition of polynomial a(X) 500 having N coefficients. Data is encoded as polynomials in fully homomorphic encryption. Polynomial a(X)=Σⱼ₌₀^{N-1}aⱼX^{j} in [symbol] is a basic operand used in CKKS-based fully homomorphic encryption (FHE) where aⱼ∈{0, 1, . . . , Q−1}.

$$ℛ = \frac{ℤ [ X ]}{{X}^{N} + 1}$$

is a polynomial ring with integer coefficients and [symbol] is a residue ring of [symbol] modulo an integer Q. The polynomial coefficients are integer modulo Q where Q is a big integer. These values may be represented using the residue number system (RNS), s.t. Q=Πᵢ₌₀^{l} qᵢ. For security reasons, Q may have a bit width ranging from few hundreds to few thousands. In RNS, a large Q can be decomposed into smaller values qᵢ that have a bit width less than or equal to <=the machine word size, e.g., 32 or 64 bits. For Q=Πᵢ₌₀ⁱ qᵢ and x∈ [symbol] , x can be decomposed into l+1 levels. The i^{th} level comprises x mod qᵢ. Therefore, each of the N coefficients is decomposed into a number of levels of small integers. The N coefficients at one decomposition level are referred to as a “limb” 502 of the polynomial. Each decomposed coefficient j in limb l can be expressed as aⱼ^{(l)}, also referred to herein as a “coefficient element” of a limb. Each limb, such as limb 502, includes the decomposed coefficient elements at level (i), a₀⁽ⁱ⁾, a₁⁽ⁱ⁾ . . . a_{N-1}⁽ⁱ⁾ of the polynomial a(X) for limb i.

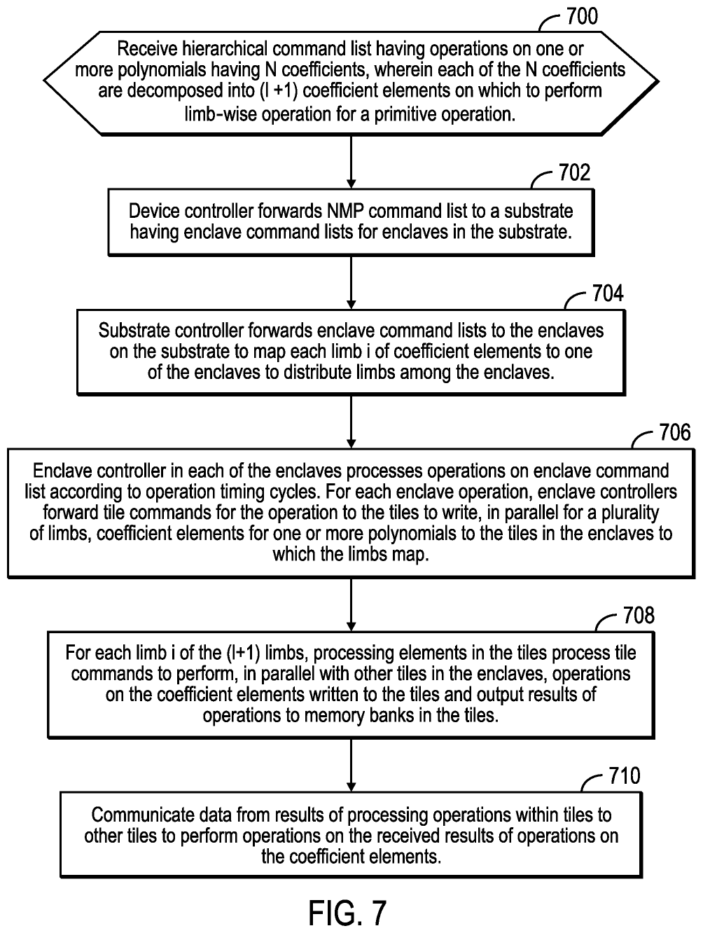

FIG. 6 illustrates two ciphertexts, where each ciphertext consists of two decomposed polynomials a(X) and b(X). The lines superimposed over the two polynomials represent four different data access patterns of the coefficient elements a and bⱼ^{(l)}, including (1) limb-wise parallelism, (2) coefficient-wise parallelism, (3) element-wise parallelism, and (4) ciphertext-wise parallelism.

Limb-wise parallelism involves data access across coefficient elements aⱼ⁽ⁱ⁾ for each limb. One limb of coefficient elements is mapped to one enclave 204i. Data accesses across different coefficient elements for each limb (limb-wise parallel) are localized to an enclave 204ᵢ. The computation may be self-contained within each enclave, i.e., no enclave-to-enclave communication is needed. Multiple enclaves 204ᵢ can execute in parallel to exploit limb-wise parallelism in the application. For instance, NTT and INTT in the ciphertext (CTXT)-plaintext (PTXT) multiplication have this data access pattern.

Coefficient-wise parallelism involves data access across limbs per each coefficient in one polynomial. When a pair of ciphertexts has computations with each other, they are mapped on one NMP substrate 200ᵢ. Otherwise, they are mapped on different NMP substrates. All limbs of the pair of ciphertext having computations with each other are mapped on one NMP substrate 200ᵢ. Data accesses across limbs for each coefficient element of the N coefficients (coefficient-wise parallel) are localized to an NMP substrate 200ᵢ. To access coefficient elements across limbs, the coefficient elements for limbs distributed across enclaves 204ᵢ need to be gathered through the vertical and horizontal connections. After the gathering of all the coefficient elements across limbs for each coefficient, since there are no data access across coefficients, data transfer between tiles in each enclave is not required. Computation is self-contained within one NMP substrate 200ᵢ and different NMP substrates 200ⱼ can operate in parallel.

Element-wise parallelism involves data access across two polynomials. A subset of the coefficient elements of one limb is mapped to one tile 206ᵢ. Data accesses across elements of a polynomial with other polynomials (element-wise parallel) are localized to a tile 206ᵢ. This data access pattern does not need any data transfer between enclaves or tiles, i.e., the computation is self-contained within each tile, and different tiles can operate in parallel. Data transfers only occur within a tile.

Ciphertext-wise parallelism exploits operations on individual ciphertexts, e.g., multiplication, addition, relinearization, rescale, etc., and is exploited on different NMP substrates 200ᵢ. Communication may be required among NMP substrates (such as using link 122) to combine the results of a primitive command, which is a composite of larger operations, at one NMP substrate 200; that are performed on other NMP substrates 200ⱼ.

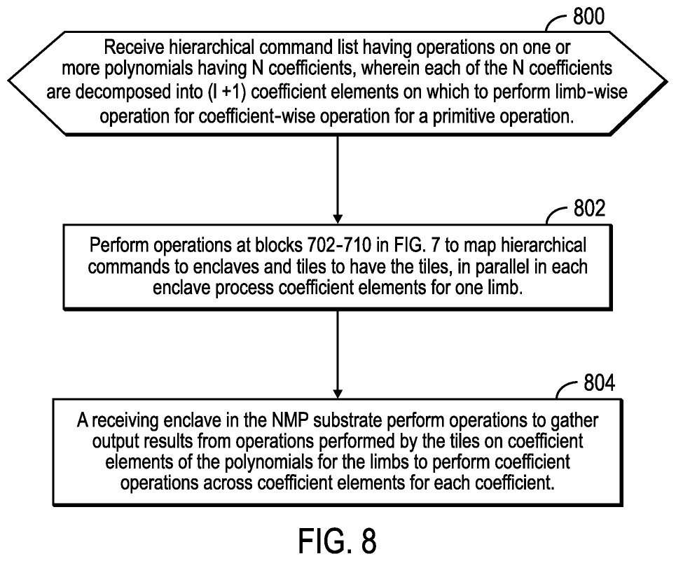

FIG. 7 illustrates an embodiment of operations performed in the hierarchical components of an NMP device 106 to process a hierarchical command list 300 to perform limb-wise operations performed in an NMP device 106ᵢ on one or more polynomials in ciphertext. The NMP device controller 111 receives (at block 700) a hierarchical command list 300, or hierarchical commands, to perform one or more operations one or more polynomials a(X), b(X), each having N coefficients, wherein each of the N coefficients are decomposed into (l+1) coefficient elements on which to perform limb-wise operation for a primitive operation. The NMP device controller 111 forwards (at block 702) the NMP command list 302i to a substrate 200ᵢ having enclave command lists 304ᵢ for enclaves 204ᵢ in the substrate 200ᵢ. The substrate controller 202 forwards (at block 704) enclave command lists 304ᵢ to the enclaves on the substrate 200ᵢ to map each limb i of coefficient to one of the enclaves to distribute limbs among the enclaves.

The enclave controller 208 in each of the enclaves 204ᵢ processes (at block 706) operations on enclave command list 304ᵢ according to operation timing cycles. For each enclave operation 306ᵢ, enclave controllers forward tile commands 308ᵢ for the operation 306 to the tiles 206ᵢ to write, in parallel for a plurality of limbs, coefficient elements for one or more polynomials to the tiles 206ᵢ in the enclaves 204ᵢ to which the limbs map. For each limb i of the (l+1) limbs, the processing elements 212 in the tiles 206ᵢ processes the tile commands 308ᵢ to perform, in parallel with other tiles 206ᵢ in the enclaves 204ᵢ, operations on the coefficient elements written to the tiles and output results of operations to memory banks in the tiles. The processing elements 212 in the tiles, executing tile commands 310ᵢ, may further communicate (at block 710) data from results of processing operations within tiles to other tiles to perform operations on the received results of operations on the coefficient elements.

With the embodiment of operations of FIG. 7, limb-wise operations are performed to process the coefficient elements for different coefficients of the same limb within the tiles of the enclave to which the limb is assigned. These operations may be performed in parallel at each level of the NMP device, for instance operations at enclaves in a substrate and within tiles in the enclaves are performed in parallel using clock cycle times provided with the hierarchical commands.

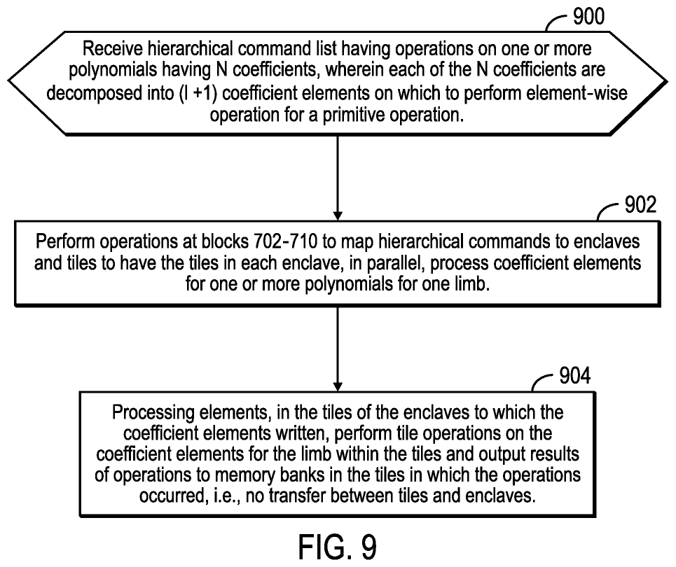

FIG. 8 illustrates an embodiment of operations performed in the hierarchical components of an NMP device 106 to process a hierarchical command list 300 to perform coefficient-wise operations performed in an NMP device 106ᵢ on one or more polynomials in ciphertext. The NMP device controller 111 receives (at block 700) a hierarchical command list 300, or hierarchical commands, to perform one or more operations one or more polynomials a(X), b(X), each having N coefficients, wherein each of the N coefficients are decomposed into (l+1) coefficient elements on which to perform a coefficient-wise operation for a primitive operation. The components in the NMP device 106ᵢ, such as the controllers 111, 202, 208, 214 and processing element array 212 perform (at block 802) the operations at blocks 702 to 710 in FIG. 7 to map hierarchical commands to enclaves and tiles to have the tiles, in parallel in each enclave process coefficient elements for one limb. A enclave controller 208 of a receiving enclave 204_{R} in the NMP substrate 200; gathers (at block 808) output results from operations performed on coefficient elements of the polynomials for the limbs to perform coefficient operations across the processed coefficient elements from different limbs.

With the embodiment of operations of FIG. 8, coefficient-wise operations are performed in parallel to process the coefficient elements from different limbs for the coefficients, to process the decomposed coefficient elements across limbs. The receiving enclave may combine the received results and perform further operations from the resulting coefficient elements for the limbs from the other enclaves.

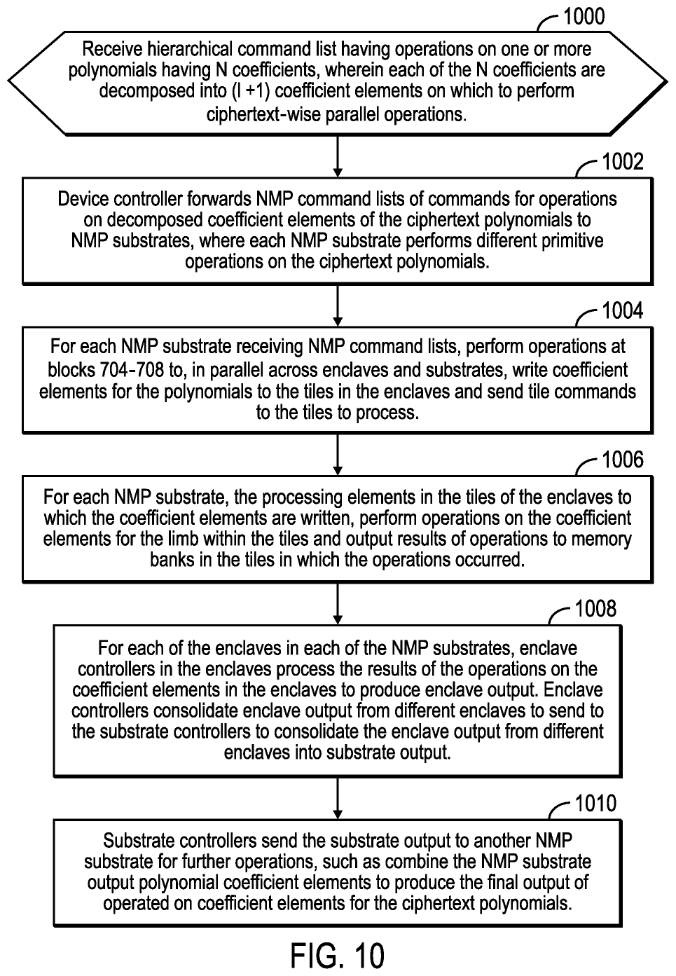

FIG. 9 illustrates an embodiment of operations performed in the hierarchical components of an NMP device 106 to process a hierarchical command list 300 to perform element-wise operations performed in an NMP device 106ᵢ on one or more polynomials in ciphertext. The NMP device controller 111 receives (at block 700) a hierarchical command list 300, or hierarchical commands, to perform one or more operations one or more polynomials a(X), b(X), each having N coefficients, wherein each of the N coefficients are decomposed into (l+1) coefficient elements on which to perform an element-wise operation for a primitive operation. The components in the NMP device 106ᵢ, such as the controllers 111, 202, 208, 214 and processing element array 212 perform (at block 802) the operations at blocks 702 to 710 in FIG. 7 to map hierarchical commands to enclaves and tiles to have the tiles, in parallel in each enclave process coefficient elements for one or more polynomials for one limb. For each limb i, processing elements 212 in the tiles 206ᵢ of the enclave 204ᵢ to which the coefficient elements are written, perform tile operations (at block 904) on the coefficient elements written to the tiles and output results of operations to memory buffers in the tiles, with no transfer between tiles and enclaves. However, data may be transferred and operated on within a tile 206ᵢ.

With the embodiment of operations of FIG. 9, element-wise operations are performed in parallel at the enclave and tile levels to process the coefficient elements from different limbs for the coefficients.

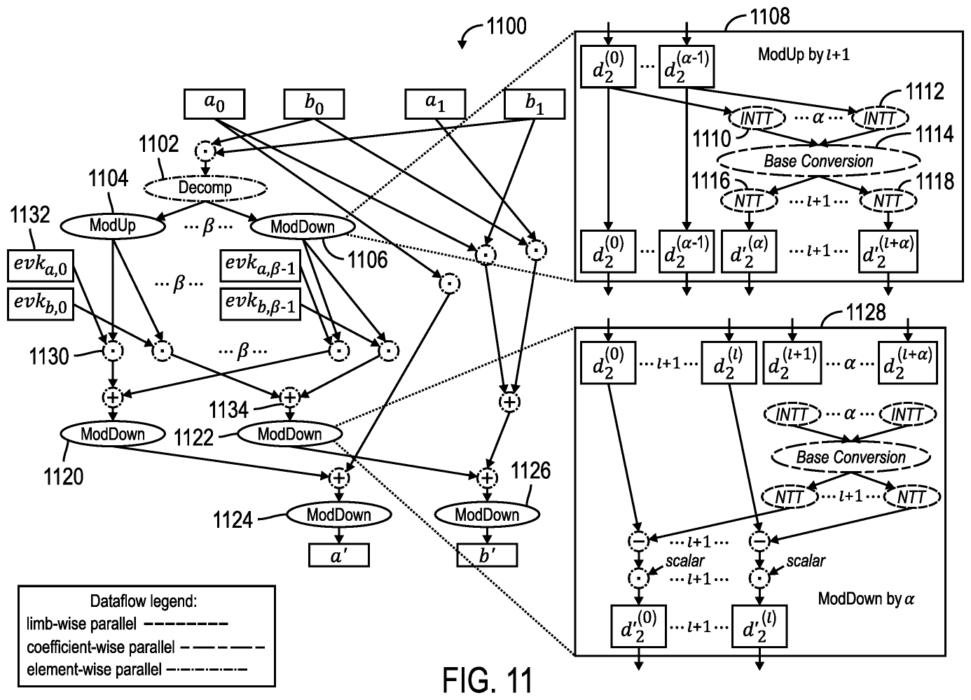

FIG. 10 illustrates an embodiment of operations performed in the hierarchical components of an NMP device 106 to process a hierarchical command list 300 to perform ciphertext-wise operations performed in an NMP device 106ᵢ on one or more polynomials in ciphertext. The NMP device controller 111 receives (at block 1000) a hierarchical command list 300, or hierarchical commands, to perform a ciphertext-wise operation on one or more polynomials a(X), b(X), each having N coefficients, wherein each of the N coefficients are decomposed into (l+1) coefficient elements on which to perform. The device controller 111 forwards (at block 1002) NMP command lists 302ᵢ, of enclave commands 304ᵢ for operations on decomposed coefficient elements of the ciphertext polynomials, to NMP substrates 200ᵢ, where each NMP substrate performs different primitive operations on the ciphertext polynomials to implement the overall ciphertext-wise operation. For each NMP substrate 200; receiving NMP command lists 302i, operations at blocks 704-708 are performed on the substrate, in parallel across enclaves and substrates, to write (at block 1004) coefficient elements for the polynomials to the tiles 206ᵢ in the enclaves 204ᵢ and send tile commands 308; to the tiles 206ᵢ to process. For each NMP substrate 200ᵢ, in parallel, the processing elements 212 in the tiles 206ᵢ of the enclaves 204ᵢ to which the coefficient elements are written, perform (at block 1006) operations on the coefficient elements for the limb within the tiles 206ᵢ and output results of operations to memory banks 210_{E}, 210_{O} in the tiles 206ᵢ in which the operations occurred.

For each of the enclaves 204ᵢ in each of the NMP substrates 200ᵢ, enclave controllers 208 in the enclaves 204ᵢ process (at block 1008) the results of the operations on the coefficient elements in the enclaves to 204ᵢ produce enclave output. Enclave controllers 208 consolidate enclave output from different enclaves 204ᵢ to send to the substrate controllers 202 to consolidate the enclave output from different enclaves into substrate output. NMP substrate controllers 202 send (at block 1010) the NMP substrate output to another NMP substrate 200; for further operations, such as combine the NMP substrate output coefficient elements across limbs to produce the final output of operated on coefficient elements for the ciphertext polynomials.

With the embodiment of operations of FIG. 10, the NMP substrates 200; may perform ciphertext-wise operations, such as multiplication, addition, re-linearization, rescaling etc., on the coefficient elements across limbs of the ciphertext-polynomials, and then the output of these operations may be further processed in another NMP substrate 200; to combine the results to produce the final output coefficient elements subject to the primitive operations of the NMP substrates. Further, the operations within each substrate, enclave and tiles may provide parallelism of operations at all these different levels to optimize and reduce latency of the ciphertext-wise operations.

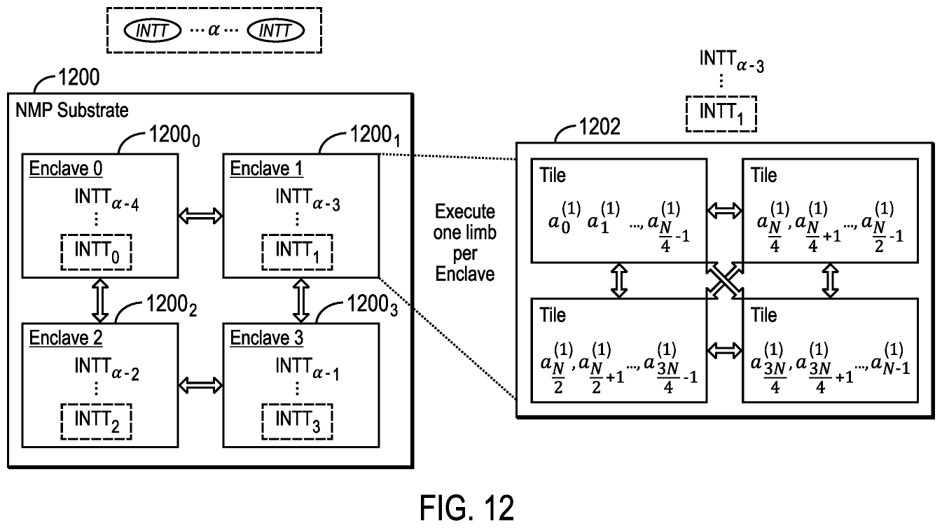

FIG. 11 illustrates a flow diagram 1100 of primitives performed on two pairs of ciphertext polynomials a₀, b₀ and a₁, b₁. The decompose function (“Decomp”) 1102 splits polynomials into a number of digits d₂ using element-wise modular arithmetic operation. In the diagram, L+1 is the initial number of limbs in the polynomial, l+1 is the current number of limbs in the polynominal, dnum is a given decomposition number, α is

$$⌈ \frac{L + 1}{dnum} ⌉ ,$$

the number of limbs per each decomposed digit, and β is

$$⌈ \frac{l + 1}{α} ⌉ ,$$

the current number of decomposed digits. Modulo raising (ModUp) operations 1104, 1106 are performed on the decomposed digits d₂, which comprise a coefficient element, from the decomposition operation, and details of the ModUp operations are shown in ModUp box 1108. The ModUp 1108 data flow involves a INTT operations 1110, 1112, a base conversion operation 1114, followed by l+1 NTT operations 1116, 1118. The decomp operation 1102 comprises an element-wise parallel operation on the coefficient elements of the ciphertext polynomials, the INTT 1110, 1112 and NTT 1116, 1118 operations comprise limb-wise parallel processing of the coefficient elements in the tiles 206ᵢ, and the base conversion operation 114 comprises a coefficient-wise parallel operation. Other operations such as modular multiplication and addition are shown as element-wise parallel operations. The ModDown 1120, 1122, 1124, 1126, or modulus reduction, operations are shown in ModDown data flow 1128. Certain of the multiplication operations, e.g., 1130, involves element-wise multiplication with an evaluation key (evk), e.g., 1132. The element-wise multiplication, e.g., 1130, and addition, e.g., 1134, operations are element-wise parallel operations.

All the different operations in the flow diagram 1100, such as the NTT, INTT, ModUp, ModDown, addition, multiplication, decomp operations, for a given pair of ciphertexts, (a₀, b₀) and (a₁, b₁), may be performed on a given NMP substrate 200ᵢ, in parallel with other such operations on other NMP substrates. If the second ciphertext is not already resident in the given NMP substrate, it is fetched from the NMP substrate that hosts the said ciphertext. In case of ciphertexts with more than two polynomials, a similar approach applies. In this case of operations on a single ciphertext, no communication between NMP substrates is necessary.

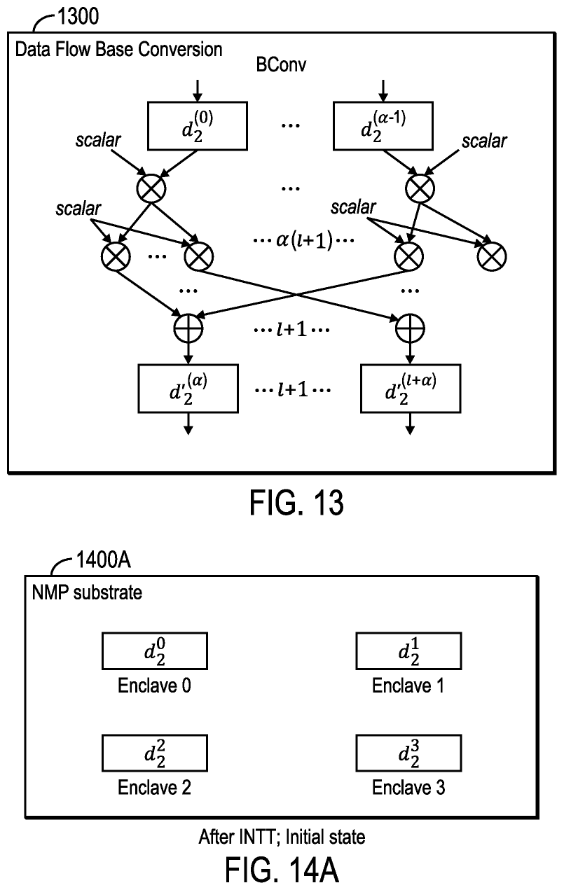

FIG. 12 shows an NMP substrate 1200 having enclaves 1200₀, 1200₁, 1200₂, and 1200₃, and limbs mapped to each enclave where the INTT operation is performed. Each enclave 1200₀, 1200₁, 1200₂, and 1200₃ performs an INTT operation on a subset of the limbs. For instance, enclave 1200₀ performs the INTT operations for limbs 0 to α−4, where α is

$$⌈ \frac{L + 1}{dnum} ⌉ ,$$

the number of limbs per each decomposed digit. Each enclave 1200; writes a subset of the coefficient elements for a limb to the tiles 206i, such as how enclave 1200₁ writes to tiles 1202, to perform the INTT operation on the coefficient elements for the limbs assigned to the enclaves. In this way, each enclave sequentially performs the INTT operations for the limbs assigned to that enclave.

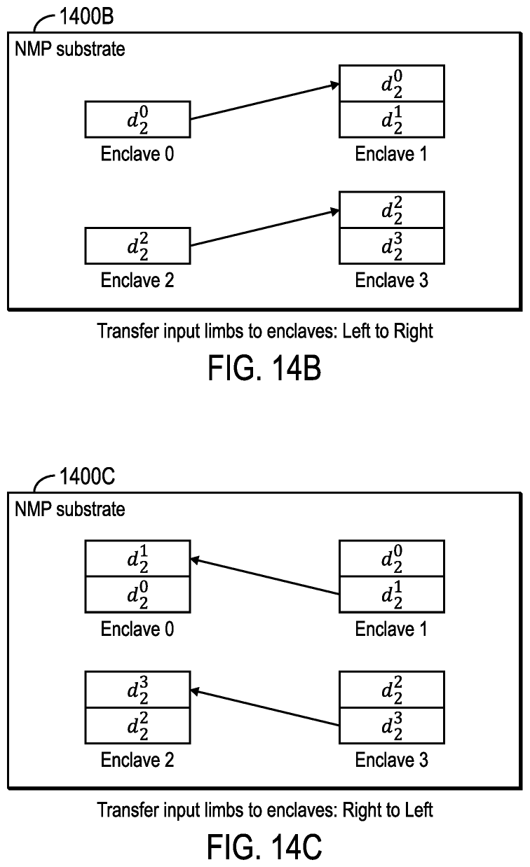

FIG. 13 illustrates a data flow of a base conversion operation 1300, including scalar multiplication operations and an addition operation performed on the decomposed polynomial d₂ having a limbs. The decomposed polynomial d₂ is produced by an NMP substrate 200ᵢ performing the INTT operation. The result of the scalar multiplication and addition operations are modified polynomial d′₂ with l additional limbs beyond a.

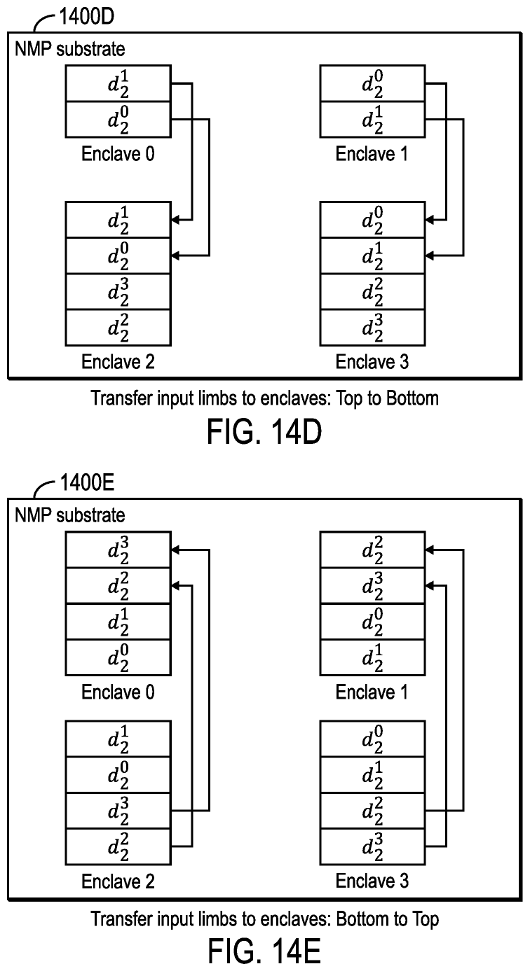

FIGS. 14A through 14H show how the enclaves 0 through 3 on an NMP substrate 1400 expand the decomposed polynomial d₂ to l limbs beyond a to perform the base conversion shown in FIG. 13A. FIG. 14A shows an initial state where the decomposed polynomial d₂ has limbs, d₂^{l}, l=0, 1, 2, 3 stored in enclaves 0 . . . 3. In FIG. 14b the limbs d₂⁰ and d₂² for limbs 0 and 2 from enclaves 0 and 2 are transferred to enclaves 1 and 3, respectively. Then in FIG. 14C the limbs d₂¹ and d₂³, initially in enclaves 1 and 3, are transferred to enclaves 0 and 2. FIG. 14D then shows how the limbs in enclaves 0 and 1 are respectively transferred to enclaves 2 and 3. FIG. 14E shows how digits in enclaves 2 and 3, prior to transfer of FIG. 14D, are transferred to enclaves 0 and 1.

FIG. 14F shows how the decomposed polynomial d₂ is expanded to limbs 4, 5, 6, and 7 from limbs, where symbol d₂^{i,j} denotes an intermediate expanded limb j created from limb i for polynomial d₂ through scalar multiplication. FIG. 14G then shows the addition operation of the base conversion of FIG. 13, where the intermediate expanded limbs d₂^{i,j} are added to create limbs 4, 5, 6, and 7 in the enclave 0, 1, 2, and 3, respectively. The end result of these base conversion operations is shown in FIG. 14H where each enclave has coefficient elements for the original limbs 0 . . . 3 and for new limbs 4 . . . 7. In this way, the diagrams of FIGS. 14A . . . 14H show how a base conversion occurs on the a limbs.

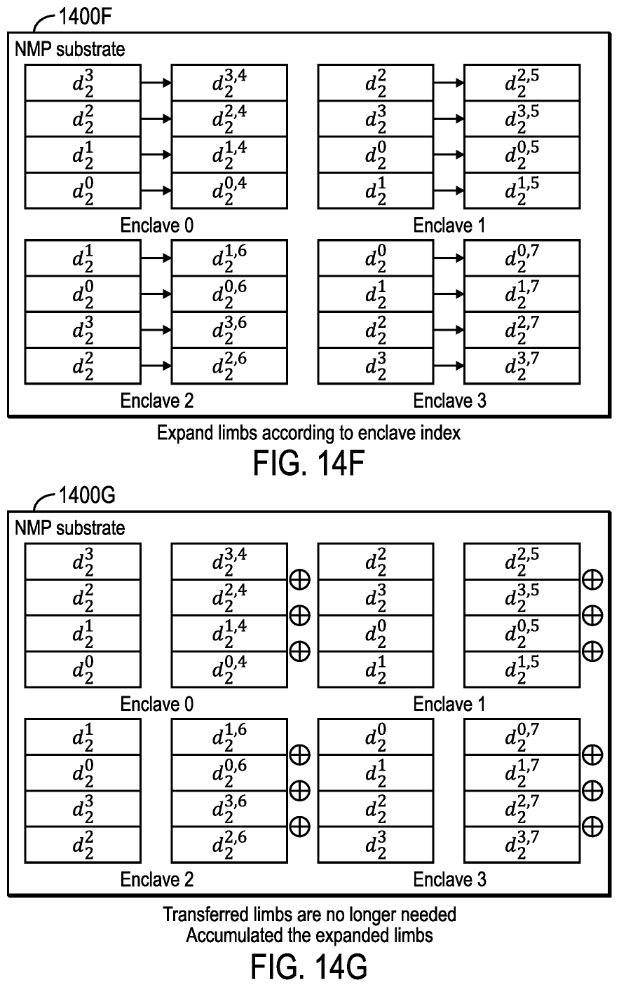

FIG. 15 shows an element-wise modular arithmetic operation occurring in a tile 1500, having a processing element 1502 and even 1504 and odd 1506 banks of four row buffers each. For example, coefficient elements for a given limb from two polynomials are read into the row buffers 1 and 2 of even 1504 and odd 1506 banks for element-wise operation and the output will be written to row buffer 3 and 4 of even bank. Row buffer 1 of each bank is used to read input data for the processing element array 1502. Row buffer 2 of each bank prepares to receive next coefficient elements to store when the processing element 1502 takes current coefficient elements from row buffer 1 of each bank. Row buffer 3 of even bank is used to store output of the processing element 1502. Row buffer 4 of even bank prepares storing output of the processing element 1502 array that takes input data from row buffer 2 of each bank. With the embodiment of FIG. 15, all processing remains within the row buffers of the tile to improve the speed and reduce energy consumption of the operations by not having to transfer data to an off-chip memory to the tile 1500.

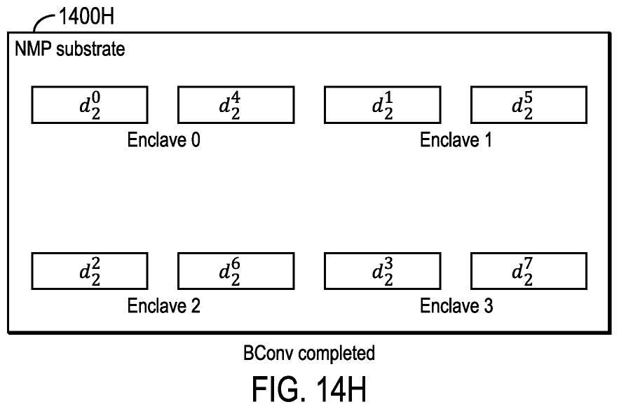

FIG. 16 provides a command timing diagram 1600 for the element-wise modular ADD operation on the embodiment shown in FIG. 15. ADD commands issued at even bank, at timing 1600₁ and 1600₂, read input from row buffers 1 and row buffers 2 of both banks, respectively, to provide the input to the processing element 1502. ADD commands issued at the even bank, such as at timings 1600₁ and 1600₂, make the processing element 1502 add the inputs from the even and odd bank and write outputs to the even bank of row buffers 3 and 4, respectively.

While a set of subarrays, at timings 1600₁, 1600₃, 1600₄, such as even.subaray.1&3 and odd.subarray.1, performs ADD commands, another set of subarrays, at timings 1600₂, 1600₅, 1600₆, even.subarray.2&4 and odd.subarray.2, prepares for the next ADD commands, leading to hiding the preparation time within the compute time, so that the subarrays 2 and 4 can be ready for the next processing element 1502 operations when the processing element 1502 completes the operations at the subarrays 1 and 3.

An embodiment maps automorphism operations in cryptographic computation as a set of back-to-back NTT and INTT operations. However, in such a case, there are no modular arithmetic operations performed within the processing elements, but rather, the interconnections between the tiles are used to move the input coefficient elements into their correct places in the final output. Another embodiment may unify the NTT and INTT operations into a single shuffle operation and perform it in a similar manner as to what is described previously.

FIG. 17 illustrates an embodiment of a system 1700 including a processor 1702 and a memory 1704 having program components executed by the processor 1702. The memory 1704 includes FHE application code 1706 including homomorphic operations on ciphertexts. A compiler 1708 includes a directed acyclic graph (DAG) mapper 1709 to produce DAGS, such as shown in FIGS. 11, 12, 13, that map hierarchical commands to the hierarchical components of the NMP device 106ᵢ. The compiler 1708 produces a plurality of directed acyclic graphs (DAGs) 1710 providing hierarchical representations of nodes having commands for execution by a hierarchy of components in the NMP device 106ᵢ, including NMP substrates 200ᵢ, where the NMP substrates 200; include enclaves 204ᵢ, and the enclaves 204ᵢ include tiles 206ᵢ that have processing elements 212 to process the decomposed coefficient elements. A hierarchical DAG tracker 1712 receives the DAGs 1710 and tracks dependencies between the nodes of the graph at all hierarchies and determines a list of ready commands 1714 that have all control and data dependencies resolved. The hierarchical DAG tracker 1712 sends ready commands 1714 at the nodes of the DAGs 1710 to the NMP command scheduler 1716. Based on readiness signals from an NMP device model 1720, the NMP command scheduler 1716 issues commands with clock cycles to an NMP device model 1720, which provides a software representation of the hardware components of an NMP device 106ᵢ, including NMP substrates 200ᵢ, enclaves 204ᵢ, and tiles 206ᵢ, to model and simulate the operations of the hierarchical hardware components in an NMP device 106.

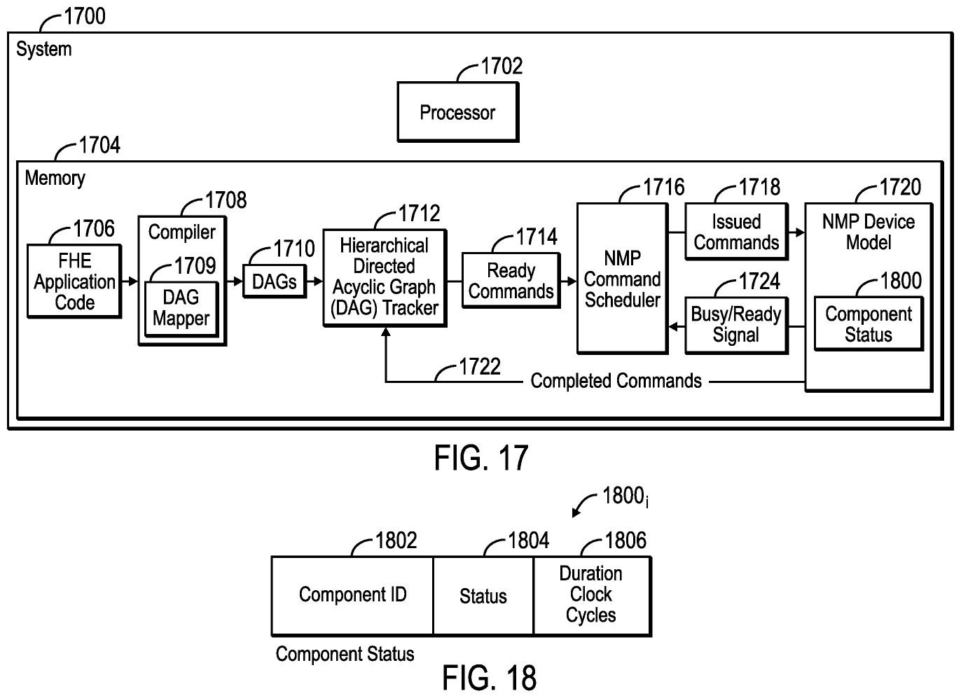

The NMP device model 1720 includes component status 1800. FIG. 18 shows that a component status 1800ᵢ entry indicates a component ID 1802 of a component, e.g., NMP substrate, enclave, tile, in the hierarchy of components, a status 1804 of the component, such as busy or ready, and a duration of clock cycles 1806 that the command is executed at the component 1802 while busy 1804. Upon the duration of clock cycles 1806 expiring, a ready signal 1724 is returned to the NMP command scheduler 1716 and a completed command signal 1722 is sent to the hierarchical DAG tracker 1712.

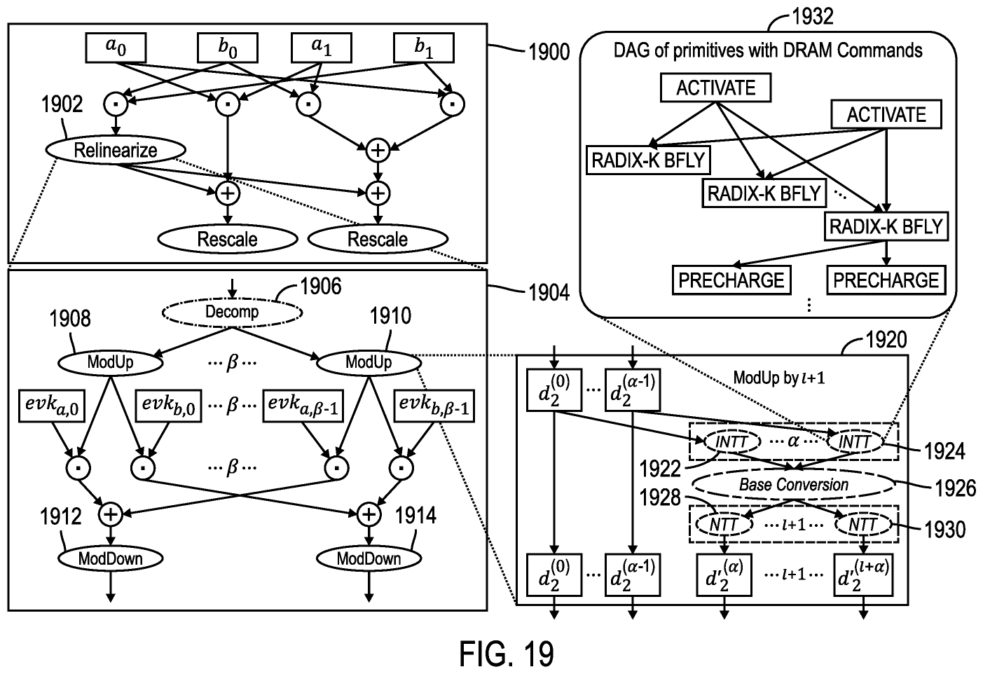

FIG. 19 illustrates an example of the DAGs 1710 generated by the compiler 1708 and shows a command graph 1900 having nodes of commands for an NMP substrate. The relinearize node 1902 may be represented as sub-graph 1904 having numbered nodes 1906, 1908, 1910, 1912, 1914 and other element-wise operations to implement the relinearize command 1902. Each of the nodes shows operations implementing the relinearize command 1902, where each operation may be implemented in an NMP Substrate 200ᵢ. The NMP substrate 200ᵢ to implement one of the operations, such as ModUp 1910, has an operation command list 302ᵢ. To implement the operations 1922, 1924, 1926, 1928, 1930, each component in the NMP substrate like the enclave 204ᵢ and tile 206ᵢ, has a command list 306ᵢ and 308ᵢ. Subgraph 1932 provides the tile commands including memory commands and operations on data in the memory banks to execute on one tile to implement the INTT operation 1924.

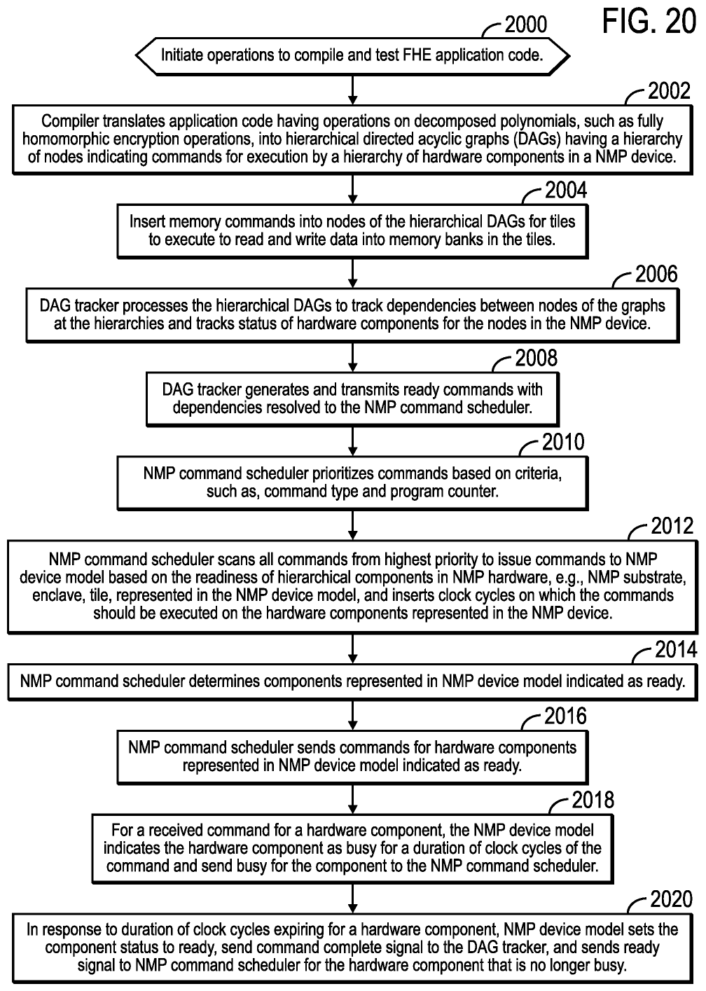

FIG. 20 illustrates an embodiment of operations performed by the compiler 1708, hierarchical DAG tracker 1712, NMP command scheduler 1716, and NMP device model 1720 to generate the hierarchical command list with clock cycles 1718 to compile and execute FHE application code 1706. Upon initiating (at block 2000) operations to compile FHE application code 1706, the compiler 1708 translates (at block 2002) application code 1706 having operations on polynomials, such as fully homomorphic encryption (FHE) operations, into hierarchical directed acyclic graphs (DAGs) 1710 having a hierarchy of nodes indicating commands for execution by a hierarchy of hardware components in an NMP device 106ᵢ to execute the FHE application code 1706. The compiler 1708 insets (at block 2004) memory commands into nodes of the hierarchical DAGs 1710 for tiles 206ᵢ to execute to read and write data into memory banks in the tiles 206ᵢ and perform operations thereon. The hierarchical DAG tracker 1712 processes (at block 2006) the hierarchical DAGs 1710 to track dependencies between nodes of the graphs at the hierarchies and removes nodes that have been completed by the NMP device model 1720.

The DAG tracker 1712 generates (at block 2008) and transmits ready commands 1714 with dependencies resolved to the NMP command scheduler 1716. The commands 1714 may be in the form of a hierarchical command list 300 (FIG. 3), where the ready commands 1714 comprise one or more of the command lists 302ᵢ, 304ᵢ 306ᵢ, and/or 308ᵢ (FIG. 3). The NMP command scheduler 1716 prioritizes (at block 2010) the ready commands 1714 based on criteria, such as command type and program counter. The NMP command scheduler 1716 scans (at block 2012) the ready commands 1714 from highest priority to issue as commands 1718, e.g., one or more of the command lists 302i, 304ᵢ 306ᵢ, and/or 308ᵢ, to the NMP device model 1720 based on the readiness of hierarchical hardware components represented in the NMP device model 1720, e.g., NMP substrate 200ᵢ, enclave 204ᵢ, tile 206ᵢ. The NMP command scheduler 1716 further inserts clock cycles at which the commands 1714 should be executed on the hardware components represented in the NMP device model 1720.

The NMP command scheduler 1716 determines (at block 2014) components represented in the NMP device model 1720 indicated as ready. The NMP command scheduler 1716 sends (at block 2016) commands 1718 to the NMP device model 1720 for hardware components represented in the NMP device model 1720 indicated as ready.

For a received command for a hardware component, the NMP device model 1720 indicates (at block 2018), in component status 1800ᵢ, the hardware component 1802 as busy in the status 1804 for a duration of clock cycles 1806 of the command and sends busy for the component to the NMP command scheduler 1716. In response to a duration of clock cycles 1806 expiring for a hardware component 1802, the NMP device model sets (at block 2020) the component 1802 status 1804 to ready, sends a command complete signal 1722 to the DAG tracker 1712, and sends ready signal 1724 to the NMP command scheduler 1716 for the hardware component 1802 that is no longer busy to inform the NMP command scheduler 1716 the hardware component 1802 is ready to receive further commands 1718.

With the described embodiments of FIG. 20, the compiler 1708 and DAG mapper 1709 generates hierarchical DAGs 1710 having nodes representing hierarchical hardware components in the NMP device 106ᵢ with the commands inserted in the nodes to be executed by the hardware component 200ᵢ, 204ᵢ, 206ᵢ represented by the nodes to perform FHE operations on decomposed polynomials. The compiled DAGs 1710 may be tested by having the DAG tracker 1712 and NMP command scheduler 1716 issue commands, such as command lists 302ᵢ, 304ᵢ, 306ᵢ, and/or 308ᵢ, to the NMP device model 1720 to simulate execution of an NMP device 106ᵢ. In this way, the NMP device model 1720 may determine whether the commands in the DAG 1710 nodes execute properly so that the DAGs 1710 may be deployed in a production environment, such as in FIG. 1.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

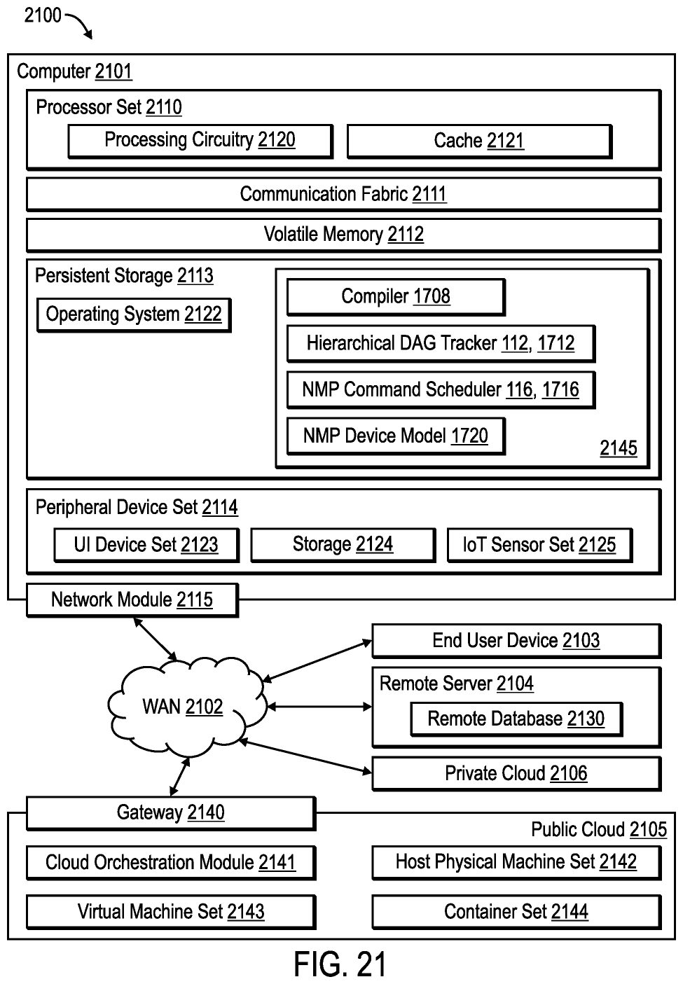

With respect to FIG. 21, computing environment 2100 contains an example of an environment for the execution of at least some of the computer code involved in performing the inventive methods, such as the programs 1708, 112, 1712, 1716, and 1720 in FIGS. 1 and 17, in block 2145, to compile an FHE application to produce directed acyclic graphs (DAGs) with commands and execute the commands, and executing the commands in the DAG. In addition to block 2145, computing environment 2100 includes, for example, computer 2101, wide area network (WAN) 2102, end user device (EUD) 2103, remote server 2104, public cloud 2105, and private cloud 2106. In this embodiment, computer 2101 includes processor set 2110 (including processing circuitry 2120 and cache 2121), communication fabric 2111, volatile memory 2112, persistent storage 2113 (including operating system 2122 and block 2145, as identified above), peripheral device set 2114 (including user interface (UI) device set 2123, storage 2124, and Internet of Things (IoT) sensor set 2125), and network module 2115. Remote server 2104 includes remote database 2130. Public cloud 2105 includes gateway 2140, cloud orchestration module 2141, host physical machine set 2142, virtual machine set 2143, and container set 2144.

COMPUTER 2101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 2130. As is well understood in the art of computer technology, and depending upon the technology, performance of a computer-implemented method may be distributed among multiple computers and/or between multiple locations. On the other hand, in this presentation of computing environment 2100, detailed discussion is focused on a single computer, specifically computer 2101, to keep the presentation as simple as possible. Computer 2101 may be located in a cloud, even though it is not shown in a cloud in FIG. 21. On the other hand, computer 2101 is not required to be in a cloud except to any extent as may be affirmatively indicated.

PROCESSOR SET 2110 includes one, or more, computer processors of any type now known or to be developed in the future. Processing circuitry 2120 may be distributed over multiple packages, for example, multiple, coordinated integrated circuit chips. Processing circuitry 2120 may implement multiple processor threads and/or multiple processor cores. Cache 2121 is memory that is located in the processor chip package(s) and is typically used for data or code that should be available for rapid access by the threads or cores running on processor set 2110. Cache memories are typically organized into multiple levels depending upon relative proximity to the processing circuitry. Alternatively, some, or all, of the cache for the processor set may be located “off chip.” In some computing environments, processor set 2110 may be designed for working with qubits and performing quantum computing.

Computer-readable program instructions are typically loaded onto computer 2101 to cause a series of operational steps to be performed by processor set 2110 of computer 2101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 2121 and the other storage media discussed below. The program instructions, and associated data, are accessed by processor set 2110 to control and direct performance of the inventive methods. In computing environment 2100, at least some of the instructions for performing the inventive methods may be stored in block 2145 in persistent storage 2113. COMMUNICATION FABRIC 2111 is the signal conduction path that allows the various components of computer 2101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 2112 is any type of volatile memory now known or to be developed in the future. Examples include dynamic type random access memory (RAM) or static type RAM. Typically, volatile memory 2112 is characterized by random access, but this is not required unless affirmatively indicated. In computer 2101, the volatile memory 2112 is located in a single package and is internal to computer 2101, but, alternatively or additionally, the volatile memory may be distributed over multiple packages and/or located externally with respect to computer 2101.

PERSISTENT STORAGE 2113 is any form of non-volatile storage for computers that is now known or to be developed in the future. The non-volatility of this storage means that the stored data is maintained regardless of whether power is being supplied to computer 2101 and/or directly to persistent storage 2113. Persistent storage 2113 may be a read only memory (ROM), but typically at least a portion of the persistent storage allows writing of data, deletion of data and re-writing of data. Some familiar forms of persistent storage include magnetic disks and solid-state storage devices. Operating system 2122 may take several forms, such as various known proprietary operating systems or open source Portable Operating System Interface-type operating systems that employ a kernel. The code included in block 2145 typically includes at least some of the computer code involved in performing the inventive methods.

PERIPHERAL DEVICE SET 2114 includes the set of peripheral devices of computer 2101. Data communication connections between the peripheral devices and the other components of computer 2101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 2123 may include components such as a display screen, speaker, microphone, wearable devices (such as goggles and smart watches), keyboard, mouse, printer, touchpad, game controllers, and haptic devices. Storage 2124 is external storage, such as an external hard drive, or insertable storage, such as an SD card. Storage 2124 may be persistent and/or volatile. In some embodiments, storage 2124 may take the form of a quantum computing storage device for storing data in the form of qubits. In embodiments where computer 2101 is required to have a large amount of storage (for example, where computer 2101 locally stores and manages a large database) then this storage may be provided by peripheral storage devices designed for storing very large amounts of data, such as a storage area network (SAN) that is shared by multiple, geographically distributed computers. IoT sensor set 2125 is made up of sensors that can be used in Internet of Things applications. For example, one sensor may be a thermometer and another sensor may be a motion detector.

NETWORK MODULE 2115 is the collection of computer software, hardware, and firmware that allows computer 2101 to communicate with other computers through WAN 2102. Network module 2115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 2115 are performed on the same physical hardware device. In other embodiments (for example, embodiments that utilize software-defined networking (SDN)), the control functions and the forwarding functions of network module 2115 are performed on physically separate devices, such that the control functions manage several different network hardware devices. Computer-readable program instructions for performing the inventive methods can typically be downloaded to computer 2101 from an external computer or external storage device through a network adapter card or network interface included in network module 2115.

WAN 2102 is any wide area network (for example, the internet) capable of communicating computer data over non-local distances by any technology for communicating computer data, now known or to be developed in the future. In some embodiments, the WAN 2102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 2103 is any computer system that is used and controlled by an end user (for example, a customer of an enterprise that operates computer 2101), and may take any of the forms discussed above in connection with computer 2101. EUD 2103 typically receives helpful and useful data from the operations of computer 2101. For example, in a hypothetical case where computer 2101 is designed to provide a recommendation to an end user, this recommendation would typically be communicated from network module 2115 of computer 2101 through WAN 2102 to EUD 2103. In this way, EUD 2103 can display, or otherwise present, the recommendation to an end user. In some embodiments, EUD 2103 may be a client device, such as thin client, heavy client, mainframe computer, desktop computer and so on.

REMOTE SERVER 2104 is any computer system that serves at least some data and/or functionality to computer 2101. Remote server 2104 may be controlled and used by the same entity that operates computer 2101. Remote server 2104 represents the machine(s) that collect and store helpful and useful data for use by other computers, such as computer 2101. For example, in a hypothetical case where computer 2101 is designed and programmed to provide a recommendation based on historical data, then this historical data may be provided to computer 2101 from remote database 2130 of remote server 2104.

PUBLIC CLOUD 2105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 2105 is performed by the computer hardware and/or software of cloud orchestration module 2141. The computing resources provided by public cloud 2105 are typically implemented by virtual computing environments that run on various computers making up the computers of host physical machine set 2142, which is the universe of physical computers in and/or available to public cloud 2105. The virtual computing environments (VCEs) typically take the form of virtual machines from virtual machine set 2143 and/or containers from container set 2144. It is understood that these VCEs may be stored as images and may be transferred among and between the various physical machine hosts, either as images or after instantiation of the VCE. Cloud orchestration module 2141 manages the transfer and storage of images, deploys new instantiations of VCEs and manages active instantiations of VCE deployments. Gateway 2140 is the collection of computer software, hardware, and firmware that allows public cloud 2105 to communicate through WAN 2102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 2106 is similar to public cloud 2105, except that the computing resources are only available for use by a single enterprise. While private cloud 2106 is depicted as being in communication with WAN 2102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 2105 and private cloud 2106 are both part of a larger hybrid cloud.

CLOUD COMPUTING SERVICES AND/OR MICROSERVICES (not separately shown in FIG. 21): private and public clouds 2106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A near memory device for performing operations on decomposed polynomials, comprising:
a plurality of enclaves;
a plurality of interconnected tiles on each enclave, wherein a tile includes:
a memory;
a processing element to perform operations on decomposed coefficients stored in the memory of the tile; and
an enclave controller in an enclave of the enclaves that is operable to perform:
receiving an operation for coefficients of a polynomial, wherein each of the coefficients are decomposed into a number of levels of coefficient elements; and
distributing the coefficient elements to the tiles in the enclave to have processing elements of the tiles load and process the coefficient elements and store the processed results.

2. The near memory device of claim 1, wherein each level of coefficient elements comprises a limb, wherein each enclave processes the coefficient elements for one of the limbs.

3. The near memory device of claim 1, wherein each of the enclaves includes an interconnection network between the tiles to enable data transfer between the tiles within one enclave, wherein the performing the operations on the coefficient elements in the enclave comprises the tiles communicating to perform the operations on the coefficient elements.

4. The near memory device of claim 1, wherein coefficient elements for one limb are processed in the tiles of only one enclave.

5. The near memory device of claim 1, further comprising:
a plurality of substrates, wherein each substrate includes a plurality of the enclaves, and wherein each enclave in the substrate is connected to two or more other enclaves in the substrate.

6. The near memory device of claim 5, wherein the substrates are implemented in at least one semiconductor device, and wherein the substrates include connections to communicate with other of the substrates.

7. The near memory device of claim 1, wherein the enclave controller is operable to instruct the processing elements in the tiles to perform operations on coefficient elements in memory buffers of the tiles comprising operations that are a member of a set of operations consisting of modular addition, modular subtraction, modular multiplication, and power-of-2 radix butterfly operations.

8. A near memory device for processing operations on decomposed polynomials, comprising:
a plurality of enclaves;
a plurality of processing tiles in the enclaves, wherein a tile includes:
an even memory bank and an odd memory bank with row buffers; and
a processing element coupled to the even memory bank and the odd memory bank; and
a tile controller operable to perform:
receive coefficients of a polynomial decomposed into a number of levels of coefficient elements;
store the coefficient elements in the even memory bank and the odd memory bank; and
direct the processing element in the tile to process the coefficient elements in the row buffers to perform an operation on the coefficient elements and write back the operated on coefficient elements to at least one of the even memory bank and the odd memory bank to return to the enclave.

9. The near memory device of claim 8, wherein memory buffers to which the coefficient elements are written comprises a first row buffer in the even and the odd memory banks of the tile, wherein a second row buffer of the even and the odd memory banks prepares to load the next coefficient elements in response to the processing element performing the operation on the coefficient elements from the first row buffer in the even and the odd memory banks.

10. The near memory device of claim 9, wherein a third row buffer of the even memory bank or odd memory bank stores output of the processing element from first row buffer of the even memory bank and the odd memory bank, and wherein a fourth row buffer of the even or odd memory bank stores output of the processing element that is based on processing coefficient elements from the second row buffer of the even memory bank and the odd memory bank.

11. The near memory device of claim 8, wherein one of the even and the odd memory banks of row buffers include source data of the coefficient elements and one of another of the even and the odd memory banks of the row buffers stores a result of a processing operation on the source data after a phase of the operation comprising a butterfly operation, is completed, the source data and destination data are swapped.

12. The near memory device of claim 8, wherein coefficient elements for one limb from two polynomials are written in first and the second row buffers to be operated on by the processing element.

13. The near memory device of claim 8, further comprising:
a plurality of substrates, wherein each substrate includes a plurality of the enclaves, and wherein each enclave in the substrate is connected to two or more other enclaves in the substrate.

14. A system, including:
a processor;
a computer readable storage medium including an application having commands to perform operations on decomposed coefficients of polynomials, wherein the processor processes the application and the operations on the decomposed coefficients of the polynomials;
a near memory device for performing the operations on the decomposed coefficients of the polynomials in the application, wherein the processor forwards the operations on the decomposed coefficients to the near memory device for processing, comprising:
a plurality of enclaves;
a plurality of interconnected tiles on each enclave, wherein a tile includes:
a memory;
a processing element to perform operations on decomposed coefficients stored in the memory of the tile; and
an enclave controller in an enclave of the enclaves that is operable to perform:
receiving an operation for coefficients of a polynomial, wherein each of the coefficients are decomposed into a number of levels of coefficient elements; and
distributing the coefficient elements to the tiles in the enclave to have processing elements of the tiles load and process the coefficient elements and store the processed results.

15. The system of claim 14, wherein each of the enclaves in the near memory device includes an interconnection network between the tiles to enable data transfer between the tiles within one enclave, wherein the performing the operations on the coefficient elements in the enclave comprises the tiles communicating to perform the operations on the coefficient elements.

16. The system of claim 14, wherein coefficient elements for one limb are processed in the tiles of only one enclave.

17. The system of claim 14, wherein the near memory device further comprises:
a plurality of substrates, wherein each substrate includes a plurality of the enclaves, and wherein each enclave in the substrate is connected to two or more other enclaves in the substrate.

18. The system of claim 14, wherein the enclave controller is operable to instruct the processing elements in the tiles to perform operations on coefficient elements in memory buffers of the tiles comprising operations that are a member of a set of operations consisting of modular addition, modular subtraction, modular multiplication, and power-of-2 radix butterfly operations.

19. A system, including:
a processor;
a computer readable storage medium including an application having commands to perform operations on decomposed coefficients of polynomials, wherein the processor processes the application and the operations on the decomposed coefficients of the polynomials;
a near memory device for performing the operations on the decomposed coefficients of the polynomials in the application, wherein the processor forwards the operations on the decomposed coefficients to the near memory device for processing, comprising:
a plurality of enclaves;
a plurality of processing tiles in the enclaves, wherein a tile includes:
an even memory bank and an odd memory bank with row buffers; and
a processing element coupled to the even memory bank and the odd memory bank; and
a tile controller operable to perform:
receive coefficients of a polynomial decomposed into a number of levels of coefficient elements;
store the coefficient elements in the even memory bank and the odd memory bank; and
direct the processing element to in the tile process the coefficient elements in the row buffers to perform an operation on the coefficient elements and write back the operated on coefficient elements to at least one of the even memory bank and the odd memory bank to return to the enclave.

20. The system of claim 19, wherein memory buffers in the near memory device to which the coefficient elements are written comprises a first row buffer in the even and the odd memory banks of the tile, wherein a second row buffer of the even and the odd memory banks prepares to load the next coefficient elements in response to the processing element performing the operation on the coefficient elements from the first row buffer in the even and the odd memory banks.

21. The system of claim 19, wherein a third row buffer of the even memory bank or odd memory bank stores output of the processing element from first row buffer of the even memory bank and the odd memory bank, and wherein a fourth row buffer of the even or odd memory bank stores output of the processing element that is based on processing coefficient elements from the second row buffer of the even memory bank and the odd memory bank.

22. The system of claim 19, wherein one of the even and the odd memory banks of row buffers include source data of the coefficient elements and one of another of the even and the odd memory banks of the row buffers stores a result of a processing operation on the source data after a phase of the operation comprising a butterfly operation, is completed, the source data and destination data are swapped.

23. The system of claim 19, wherein coefficient elements for one limb from two polynomials are written in first and the second row buffers to be operated on by the processing element.

24. A method implemented in a near memory device for performing operations on decomposed polynomials, comprising:
performing, by a processing element in a tile, wherein the tile is one of a plurality interconnected tiles on an enclave of a plurality of enclaves on the near memory device, operations on decomposed coefficients stored in a memory of the tile; and
receiving, by an enclave controller in an enclave of the enclaves, an operation for coefficients of a polynomial, wherein each of the coefficients are decomposed into a number of levels of coefficient elements; and
distributing, by the enclave controller, the coefficient elements to the tiles in the enclave to have processing elements of the tiles load and process the coefficient elements and store the processed results.

25. The method of claim 24, further comprising:
instructing, by the enclave controller, the processing elements in the tiles to perform operations on coefficient elements in memory buffers of the tiles comprising operations that are a member of a set of operations consisting of modular addition, modular subtraction, modular multiplication, and power-of-2 radix butterfly operations.
